(19) United States
(12) Patent Application Publication
(10) Pub. No.: US 2024/0420013 A1
(43) Pub. Date: Dec. 19, 2024

(54) DEBIASED TRAINING OF MACHINE LEARNING SYSTEMS

(71) Applicant: Pinterest, Inc., San Francisco, CA (US)

(72) Inventors: Pingjie Xiao, San Carlos, CA (US); Peifeng Yin, Foster City, CA (US)

(73) Assignee: Pinterest, Inc., San Francisco, CA (US)

(21) Appl. No.: 18/335,212

(22) Filed: Jun. 15, 2023

(51) Int. Cl. G06N 20/00

(52) U.S. Cl. CPC G06N 20/00

(57) ABSTRACT

Described are systems and methods for generating a debiased training dataset and training one or more stages of a multi-stage recommendation system and/or service using the debiased training dataset. Rather than generating training datasets from the output data generated by the multi-stage recommendation system and/or data served by later stages of the multi-stage recommendation system, debiased training datasets may be generated from data that was served by the particular stage of the multi-stage recommendation system that is to be trained using the generated debiased training dataset. The debiased training dataset may be generated by generating pseudo-labels for each data record and comparing the generated pseudo-labels against two thresholds to generate a binary classification of the data records.

### BACKGROUND

The amount of accessible content is ever expanding. For example, there are many online services that host and maintain content for their users and subscribers. Further, in connection with the hosting and maintenance of the accessible content, many online services may provide search, recommendation, personalization, and/or other services to facilitate access to the content. Oftentimes, such online services will employ multi-stage recommendation systems and/or services which may include multiple trained machine learning models configured to determine and/or identify content for users of the online service from a corpus of content. However, many such multi-stage recommendation systems and/or services are oftentimes trained using training datasets having selection bias. For example, a training data set for a particular stage of a multi-stage recommendation system and/or service may be generated from data that was served by the multi-stage recommendation system and/or service and/or the later stages of the multi-stage recommendation system and/or service. However, such data may be markedly different than the initial data and the data that may be served by the earlier stages of the multi-stage recommendation system and/or service. Accordingly, the training dataset generated from data that is served by the multi-stage recommendation system and/or service and/or the later stages of the multi-stage recommendation system and/or service may not be representative of the data on which each stage of such multi-stage recommendation systems and/or services serve. Accordingly, this may lead to recommendation systems and/or services that may not achieve the desired performance in connection with the recommendation systems and/or services.

### BRIEF DESCRIPTION OF THE DRAWINGS

FIGS. 1A and 1B are illustrations of an exemplary computing environment, according to exemplary embodiments of the present disclosure.

FIG. 2 is a block diagram illustrating an exemplary interaction between a client device, an online service, and a datastore, according to exemplary embodiments of the present disclosure.

FIG. 3 is a block diagram illustrating an exemplary multi-stage recommendation system, according to exemplary embodiments of the present disclosure.

FIG. 4 is a flow diagram of an exemplary machine learning model training process, according to exemplary embodiments of the present disclosure.

FIG. 5 is a flow diagram of an exemplary deep neural network training process, according to exemplary embodiments of the present disclosure.

FIG. 6 is an illustration of an exemplary client device, according to exemplary embodiments of the present disclosure.

FIG. 7 is an illustration of an exemplary configuration of a client device, such as that illustrated in FIG. 6, according to exemplary embodiments of the present disclosure.

FIG. 8 is an illustration of an exemplary server system, according to exemplary embodiments of the present disclosure.

### DETAILED DESCRIPTION

As is set forth in greater detail below, embodiments of the present disclosure are generally directed to systems and methods for generating a debiased training dataset and training one or more stages of a multi-stage recommendation system and/or service using the debiased training dataset. According to exemplary embodiments of the present disclosure, the multi-stage recommendation system may include one or more machine learning models configured to identify recommended content from a corpus of content items that may be provided to a user of an online service in response to a request for content items. The recommended content provided to the user may be based on various factors, such as relevancy, user history, user preferences, contextual information, content objectives, and the like.

According to certain aspects of the present disclosure, each stage of the multi-stage recommendation system may include one or more machine learning models, such as a deep neural network (“DNN”), that may be trained to determine and/or identify content from an input corpus of content based on certain criteria. Accordingly, each stage of the multi-stage recommendation system may be configured to successively filter and rank the content, so as to reduce and narrow down the number of content items from the corpus of content items in determining one or more content items to provide to the user.

In exemplary implementations of the present disclosure, rather than generating training datasets from the output data generated by the multi-stage recommendation system and/or data served by later stages of the multi-stage recommendation system, debiased training datasets may be generated from data that was served by the particular stage of the multi-stage recommendation system that is to be trained using the generated debiased training dataset. Accordingly, the data served by the stage of the multi-stage recommendation system to be trained as the initial dataset to generate the debiased training dataset can mitigate the introduction of selection bias in the training dataset and can include a distribution of data that is more representative of the data that may be served by the stage of the multi-stage recommendation system to be trained.

In generating the debiased training dataset, each data record of the initial dataset may be processed by a machine learning model to generate and assign pseudo-labels for each data record of the initial data set. According to aspects of the present disclosure, the machine learning model used to generate the pseudo-labels may include an existing machine learning model that is implemented as a portion of the multi-stage recommendation system. The pseudo-labels generated and assigned to each data record may represent a predicted likelihood that the user may interact with each data record. In exemplary implementations, the pseudo-labels may include a numerical value (e.g., between 0 and 1) generated by the trained machine learning model that represents an expected relevance and/or likelihood that a user may interact with the corresponding data record. For example, the numerical value can include an expected click-through-rate (CTR), expected convergence rate (CVR), expected relevance score, expected cost per action, and the like, where a higher numerical value may indicate a greater likelihood and/or expectation that a user may interact with the corresponding data record and a lower numerical value may indicate a lower likelihood and/or expectation that a user may interact with the corresponding data record. Further, utilizing an existing machine learning model to generate the pseudo-labels for each data record can reduce infrastructure cost, complexities, and the like in connection with training and maintaining a multi-stage recommendation system.

In addition to generating pseudo-labels for each data record of the initial dataset, exemplary implementations of the present disclosure also determine thresholds against which the pseudo-labels may be compared. The determined thresholds may include an upper threshold and a lower threshold, and comparison of the pseudo-labels against the upper and lower thresholds may facilitate determination of a binary classification of the data records. According to exemplary implementations, if the assigned pseudo-label of a data record is greater than the upper threshold, the data record may be assigned a positive label. Conversely, data records having pseudo-labels less than the lower threshold may be assigned a negative label. Further data records having pseudo-labels between the upper threshold and the lower threshold may be discarded and not included in the training dataset. The debiased training dataset may then be generated with the data records assigned positive labels and negative labels. The debiased training dataset may then be used to train a machine learning model that may be employed as a stage of the multi-stage recommendation system.

Advantageously, the exemplary embodiments of the present disclosure can facilitate training of one or more stages of a multi-stage recommendation system using a debiased training dataset. According to exemplary embodiments of the present disclosure, a dataset that was served by the machine learning model to be trained may be used as the initial dataset from which the debiased training dataset may be generated. This dataset can include a distribution of data that is more representative of the data that may be served by the machine learning model to be trained and can mitigate the introduction of selection bias in the training dataset. Further, utilizing an existing machine learning model to generate the pseudo-labels for each data record can reduce infrastructure cost, complexities, and the like in connection with training and maintaining a multi-stage recommendation system.

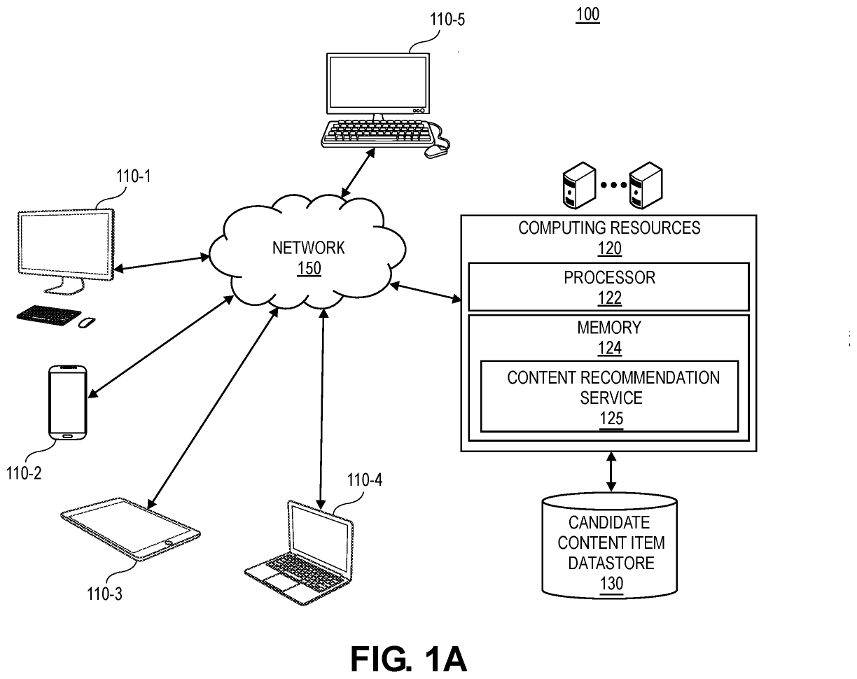

FIGS. 1A and 1B are illustrations of an exemplary computing environment 100, according to exemplary embodiments of the present disclosure.

As shown in FIG. 1A, computing environment 100 may include one or more client devices 110 (e.g., client device 110-1, 110-2, 110-3, 110-4, and/or 110-5), also referred to as user devices, for connecting over network 150 to access computing resources 120. Client devices 110 may include any type of computing device, such as a smartphone, tablet, laptop computer, desktop computer, wearable, etc., and network 150 may include any wired or wireless network (e.g., the Internet, cellular, satellite, Bluetooth, Wi-Fi, etc.) that can facilitate communications between client devices 110 and computing resources 120. Computing resources 120 may include one or more processor(s) 122 and one or more memory 124, which may store one or more applications, such as content recommendation service 125, that may be executed by processor(s) 122 to cause processor(s) 122 of computing resources 120 to perform various functions and/or actions. According to aspects of the present disclosure, computing resources 120 may represent at least a portion of a networked computing system that may be configured to provide online applications, services, computing platforms, servers, and the like, such as a social networking service, social media platform, e-commerce platform, content recommendation services, search services, and the like, that may be configured to execute on a networked computing system. Further, computing resources 120 may communicate with one or more datastore(s), such as candidate content item datastore 130, which may be configured to store and maintain a corpus of digital content items from which content recommendation service 125 may determine and/or identify content to provide to client devices 110. The content items stored and maintained by candidate content item datastore 130 may include any type of digital content, such as digital images, videos, documents, advertisements, and the like.

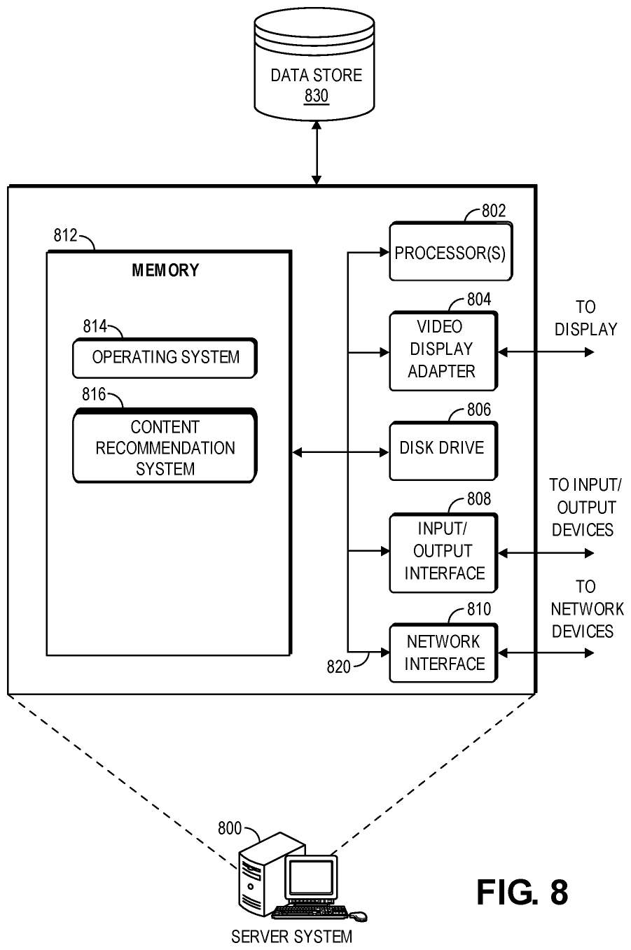

According to exemplary implementations of the present disclosure, computing resources 120 may be representative of computing resources that may form a portion of a larger networked computing platform (e.g., a cloud computing platform, and the like), which may be accessed by client devices 110. Computing resources 120 may provide various services and/or resources and do not require end-user knowledge of the physical premises and configuration of the system that delivers the services. For example, computing resources 120 may include “on-demand computing platforms,” “software as a service (Saas),” “infrastructure as a service (IaaS),” “platform as a service (PaaS),” “platform computing,” “network-accessible platforms,” “data centers,” “virtual computing platforms,” and so forth. As shown in FIG. 1A, computing resources 120 may be configured to execute and/or provide a social media platform, a social networking service, a recommendation service, a search service, an e-commerce platform, or any other form of interactive computing. Example components of a remote computing resource, which may be used to implement computing resources 120, are discussed below with respect to FIG. 8.

As illustrated in FIGS. 1A and 1B client devices 110 may access and/or interact with content recommendation service 125 through network 150 via one or more applications 115 operating and/or executing on client devices 110. For example, users associated with client devices 110 may launch and/or execute such an application on client devices 110 to access and/or interact with applications and/or services executing on computing resources 120 via network 150. According to aspects of the present disclosure, a user may, via execution of applications 115 on client devices 110, access or log into services executing on computing resources 120 by submitting one or more credentials (e.g., username/password, biometrics, secure token, etc.) through a user interface presented on client devices 110.

Once logged into services executing on remote computing resources 120, users associated with client devices 110 may navigate, view, access, and/or otherwise consume content items on client devices 110 as part of a social media platform or environment, a networking platform or environment, an e-commerce platform or environment, or through any other form of interactive computing. In connection with the user's activity on client devices 110 with the online services provided by computing resources 120, which may include the consumption of content, a request for content may be received from client devices 110 by computing resources 120. For example, a request for content may be included in a query (e.g., a text-based query, an image query, etc.), a request to access a homepage and/or home feed, a request for recommended content items, browsing and/or consuming content via the service, and the like. Alternatively and/or in addition, services executing on remote computing resources 120 may push content items to client devices 110. For example, services executing on remote computing resources 120 may push content items to client devices 110 on a periodic basis, after a certain period of time has elapsed, based on certain activity associated with client devices 110, upon identification of relevant and/or recommended content items that may be provided to client devices 110, and the like.

In response to a request for content, content recommendation service 125 may obtain various information and parameters associated with the user (e.g., user history information, user profile information, contextual information, embeddings and/or vectors representative of the user, etc.) to determine and/or identify recommended content from the corpus of content items stored and/or maintained by candidate content item datastore 130. The obtained information and parameters may be processed by content recommendation service 125 to determine and/or identify one or more recommended content items to be presented to the user. According to exemplary embodiments of the present disclosure, content recommendation service 125 may include a multi-stage recommendation system and/or service that may include one or more machine learning models, such as deep neural networks (“DNN”), trained to determine and/or identify recommended content from a corpus of content items stored and/or maintained by candidate content item datastore 130 to present to users associated with any of client devices 110. In exemplary implementations, each stage of the multi-stage recommendation system may include one or more machine learning models and may be configured to successively filter and rank the content, so as to reduce and narrow down the number of content items from the corpus of content items in determining the one or more recommended content items to provide to the user. In other implementations, portions of content recommendation service 125 may be performed on client devices 110. As will be appreciated, any variation of processing and/or other operations of the disclosed implementations may be performed on one or many different devices.

According to exemplary implementations, one or more stages of the multi-stage recommendation system forming content recommendation service 125 may be trained using a debiased training dataset generated according to exemplary embodiments of the present disclosure. For example, the debiased training datasets may be generated from data that was previously served by the particular stage of the multi-stage recommendation system that is to be trained using the generated debiased training dataset. In exemplary implementations where the particular stage of the multi-stage recommendation system that is to be trained is trained periodically, the data that was served by the particular stage of the multi-stage recommendation system during the previous period may be utilized as the initial dataset. Accordingly, utilizing the data served by the stage of the multi-stage recommendation system to be trained as the initial dataset to generate the debiased training dataset can mitigate the introduction of selection bias in the training dataset and can include a distribution of data that is more representative of the data that may be served by the stage of the multi-stage recommendation system to be trained.

In generating the debiased training dataset, each data record of the initial dataset may be processed by a machine learning model to generate and assign pseudo-labels for each data record of the initial data set. According to aspects of the present disclosure, the machine learning model used to generate the pseudo-labels may include an existing machine learning model that is implemented as a stage of the multi-stage recommendation system. The pseudo-labels generated and assigned to each data record may represent a predicted relevancy and/or likelihood that the user may interact with each data record. In exemplary implementations, the pseudo-labels may include a numerical value (e.g., between 0 and 1) generated by the trained machine learning model that represents an expected relevance and/or likelihood that a user may interact with the corresponding data record. For example, the numerical value can include an expected click-through-rate (CTR), expected convergence rate (CVR), expected relevance score, expected cost per action, and the like, where a higher numerical value may indicate a greater likelihood and/or expectation that a user may interact with the corresponding data record and a lower numerical value may indicate a lower likelihood and/or expectation that a user may interact with the corresponding data record. Further, utilizing an existing machine learning model to generate the pseudo-labels for each data record can reduce the infrastructure cost, complexities, and the like in connection with training and maintaining a multi-stage recommendation system.

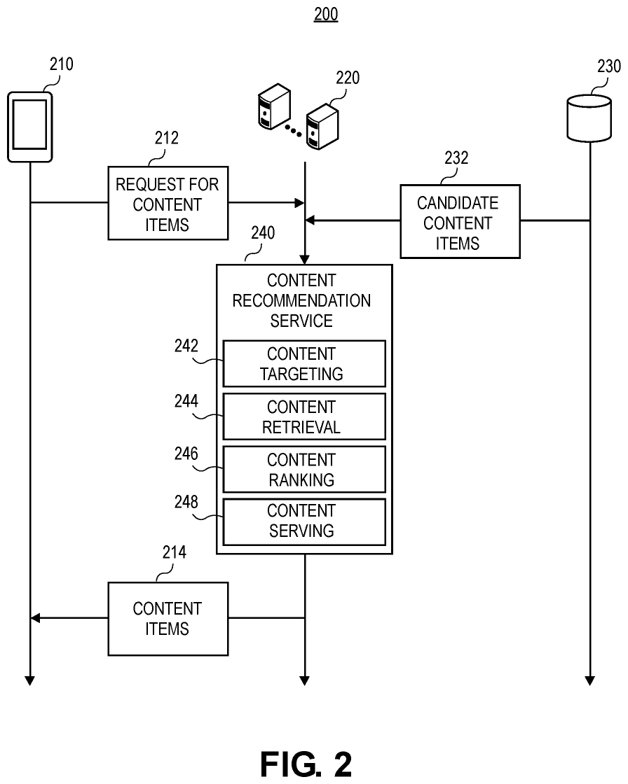

In addition to generating pseudo-labels for each data record of the initial dataset, exemplary implementations of the present disclosure also determine thresholds against which the pseudo-labels may be compared. The determined thresholds may include an upper threshold and a lower threshold, and comparison of the pseudo-labels against the upper and lower thresholds may facilitate determination of a binary classification of the data records. According to exemplary implementations, if the assigned pseudo-label of a data record is greater than the upper threshold, the data record may be assigned a positive label. Conversely, data records having pseudo-labels less than the lower threshold may be assigned a negative label. Further data records having pseudo-labels between the upper threshold and the lower threshold may be discarded and not included in the training dataset. The debiased training dataset may then be generated with the remaining data records assigned positive labels and negative labels. The debiased training dataset may then be used to train a machine learning model that may be employed as a stage of the multi-stage recommendation system that forms content recommendation system 125. Generation of the debiased training dataset and training the machine learning model is described in further detail herein in connection with FIGS. 3-5.

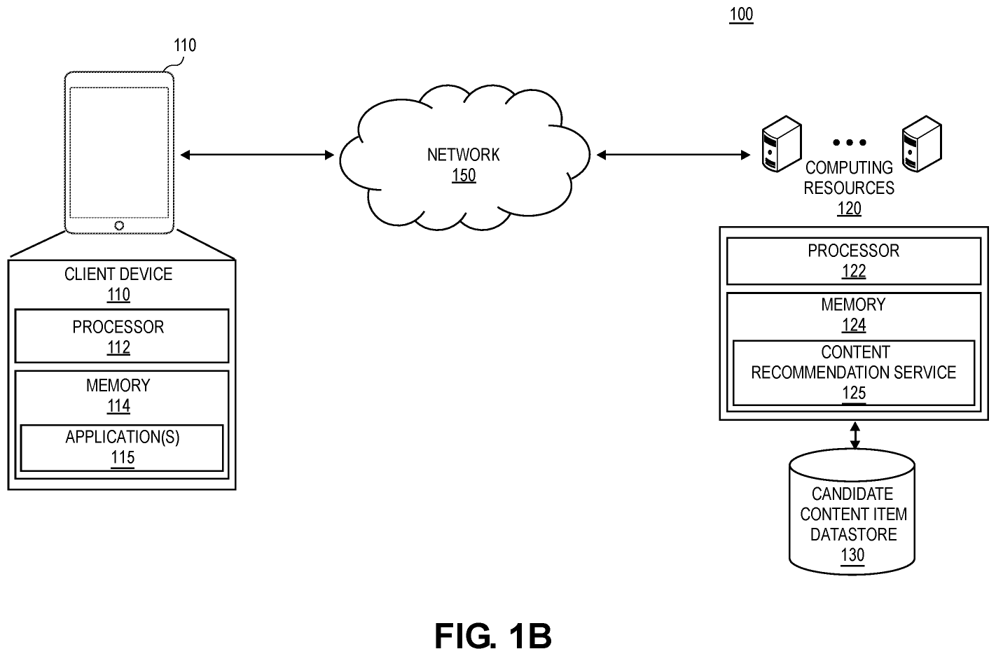

FIG. 2 is a block diagram illustrating an exemplary interaction 200 between a client device, an online service, and a datastore, according to exemplary embodiments of the present disclosure.

FIG. 2 illustrates an exemplary interaction 200 between client device 210, online service 220, and datastore 230, according to exemplary embodiments of the present disclosure. Client device 210 may include any of client devices 110, online service 220 may include an online service, such as a social networking service, social media platform, e-commerce platform, content recommendation services, search services, and the like, that may be configured to execute on online computing resources, such as computing resources 120, and datastore 230 may include candidate content item datastore 130, which may be configured to store and maintain a corpus of digital content items (e.g., images, videos, documents, advertisements, links, etc.).

Further, online service 220 may also include content recommendation service 240. According to exemplary embodiments of the present disclosure, content recommendation service 240 may include a multi-stage recommendation system, which may include one or more machine learning models configured to identify recommended content from a corpus of content items (e.g., stored and maintained in datastore 230) that may be provided to client device 210. Each stage of the multi-stage recommendation system may be configured to successively filter and rank content items obtained from datastore 230, so as to reduce and narrow down the number of content items from the corpus of content items in determining one or more content items to provide to client device 210. In the exemplary implementation shown in FIG. 2, the multi-stage recommendation system of content recommendation service 240 may include four stages: a first stage may include content targeting stage 242, a second stage may include content retrieval stage 244, a third stage may include content ranking stage 246, and a fourth stage may include content serving stage 248. Each stage may include various probabilistic models, rule-based models, machine learning models, and the like to filter and/or rank content at each respective stage. Further, although the illustrated implementation shows a multi-stage recommendation system having four stages, in other implementations, recommendation service 240 may include a single stage or any other number of stages in determining and serving recommended content to client device 210.

According to exemplary embodiments of the present disclosure, one or more machine learning models that form one or more stages (e.g., content targeting stage 242, content retrieval stage 244, content ranking stage 246, and/or content serving stage 248) of content recommendation service 240 may be trained using a debiased training dataset generated according to exemplary embodiments of the present disclosure. For example, the debiased training dataset may be generated from data that was served by the particular stage of the multi-stage recommendation system that is to be trained using the generated debiased training dataset. Accordingly, utilizing the data that was served by the stage of the multi-stage recommendation system to be trained as the initial dataset to generate the debiased training dataset can mitigate the introduction of selection bias in the training dataset and can include a distribution of data that is more representative of the data that may be served by the stage of the multi-stage recommendation system to be trained. For example, in exemplary implementations where the stage of the multi-stage recommendation system that is to be trained is trained periodically, the data that was served by the particular stage of the multi-stage recommendation system during the previous period may be utilized as the initial dataset. For example, if the machine learning model is to be trained daily, the data that was served by the machine learning model during the previous day may be utilized as the initial dataset. Generation of the debiased training dataset and training of the machine learning models is described in further detail herein at least in connection with FIGS. 3-5.

As shown in FIG. 2, client device 210 may access online service 220 and send to online service 220 a request for content items 212. Request for content items 212 may, for example, by included in a query (e.g., a text-based query, an image query, etc.), a request to access a homepage and/or home feed, a request for recommended content items, browsing and/or consuming content via the service, and the like. In response to the request for content items 212, online service 220 may obtain or otherwise receive candidate content items 232 from datastore 230. Accordingly, content recommendation service 240 may be configured to filter and rank candidate content items 232 to identify recommended content from candidate content items 232 to provide to client device 210. For example, each of content targeting stage 242, content retrieval stage 244, content ranking stage 246, and content serving stage 248 may successively filter and/or rank candidate content items 232 in identifying recommended content to provide to client device 210.

According to exemplary embodiments of the present disclosure, content targeting stage 242 may first apply certain content criteria to candidate content items 232 to select content from candidate content items 232 that meet the content criteria. For example, the request for content items 212 may include certain content criteria (e.g., content type, content category, content size, client device type, etc.) in connection with the content being requested. Alternatively and/or in addition, certain content criteria may also be determined by online service 220 and/or content recommendation service 240. For example, content targeting stage 242 may be configured to determine and/or obtain content criteria associated with the request for content items 212. Accordingly, content targeting stage 242 may apply the content criteria to select a subset of content from candidate content items 232 that meet the content criteria.

After content targeting stage 242 has identified content from candidate content items 232 that meet the content criteria, the content identified by content targeting stage 242 may be further refined by content retrieval stage 244. According to exemplary implementations of the present disclosure, content retrieval stage 244 may include one or more machine learning models configured to further refine the remaining content identified by content targeting stage 242. For example, the one or more machine learning models of content retrieval stage 244 may receive user information, content request information, and the like as inputs, and the one or more machine learning models of content retrieval stage 244 may determine a relevancy score for each content item identified by targeting stage 242. According to certain aspects of the present disclosure, the user information may include a user embedding that is representative of the user who submitted the request for content items 212 and may be configured to predict content items with which the user is expected to engage, and the content request information may include a query embedding representative of the request for content. In an exemplary implementation of the present disclosure, content recommendation service 240 may be configured to determine product recommendations online in real-time, where the query embedding is computed online in real-time while the user embedding may be pre-computed offline. Further, according to aspects of the present disclosure, a dot product of the user embedding and the query embedding may be computed in determining the relevancy score for each content item. Accordingly, content items with relevancy scores above a threshold value may be selected and provided to content ranking stage 246.

The content items selected and provided by content retrieval stage 244 may be further refined and/or ranked by content ranking stage 246. According to exemplary implementations of the present disclosure, content ranking stage 246 may employ one or more machine learning models, probabilistic models, rule-based models, and the like, to further refine and/or rank the content items selected and received from content ranking stage 246. According to aspects of the present disclosure, content ranking stage 246 may process the content items selected and provided by content retrieval stage 244 based on certain objectives associated with the content items to rank the content items. This may include, for example, determining the relevancy of the content items, an expected engagement (e.g., a clickthrough rate, a conversion rate, etc.) of the user with the content item, and the like. Accordingly, the highest ranked content items, and/or the content items above a threshold ranking may be returned and provided by content ranking stage 246 to content serving stage 248. Content serving stage 248 may employ one or more machine learning models, probabilistic models, rule-based models, and the like to make a further determination as to which content items may be provided to client device 210. Accordingly, the selected content items may be provided to client device 210 as content items 214. Optionally, content serving stage 248 may also determine display parameters (e.g., position, duration, etc.) associated with the provided content items.

FIG. 3 is a block diagram illustrating an exemplary multi-stage recommendation system 300, according to exemplary embodiments of the present disclosure. FIG. 3 illustrates an exemplary implementation where a debiased training dataset may be generated to be used in the training of content retrieval stage 304.

As shown in FIG. 3, multi-stage recommendation system 300 may include content targeting stage 302, content retrieval stage 304, content ranking stage 306, and content serving stage 308. Although FIG. 3 illustrates multi-stage recommendation system 300 to include four stages, other implementations of the present disclosure may include any number of stages. As illustrated, corpus of content items 310-A may be obtained and/or provided to content targeting stage 302 in response to a request for content items. Accordingly, content targeting stage 302 may determine and/or select a subset of content items 310-B from corpus of content items 310-A and provide content items 310-B to content retrieval stage 304. For example, content targeting stage 302 may employ one or more machine learning models, probabilistic models, rule-based models, and the like to select content items 310-B from content items 310-A based on content criteria, which may be associated with the request for content items. Accordingly, content targeting stage 302 may apply the content criteria to select content items 310-B as a subset of content from content items 310-A that meet the content criteria.

Content items 310-B may then be provided to content retrieval stage 304, which may employ one or more machine learning models to further refine and/or rank the content items in identifying recommended content to provide to a user. According to exemplary implementations of the present disclosure, the one or more machine learning models of content retrieval stage 304 may be configured to further select a subset of content items 310-B based on user information, content request information, and the like that may be associated with the request for content. According to certain aspects of the present disclosure, a relevancy score may be generated for content items 310-B based on the user information and the content request information. The user information may include a user embedding that is representative of the user who submitted the request for content items and may be configured to predict content items with which the user is expected to engage, and the content request information may include a query embedding representative of the request for content. In an exemplary implementation of the present disclosure, multi-stage recommendation system 300 may be configured to determine product recommendations online in real-time, where the query embedding is computed online in real-time while the user embedding may be pre-computed offline. Further, according to aspects of the present disclosure, a dot product of the user embedding and the query embedding may be computed in determining the relevancy score for each content item. As shown in FIG. 3, content retrieval stage 304 may identify content items 310-C as a subset of content items 310-B and provide content items 310-C to content ranking stage 306. Accordingly, content items 310-C that were selected and provided to content ranking stage 306 may have relevancy scores above a threshold value.

In turn, content items 310-C may then be provided to content ranking stage 306, which may employ one or more machine learning models, probabilistic models, rule-based models, and the like to select a subset of content items from content items 310-C to further refine and/or rank the content items. According to aspects of the present disclosure, content ranking stage 306 may process content items 310-C based on certain objectives associated with the content items and the request for content items to rank content items 310-C. This may include, for example, determining the relevancy of the content items, an expected engagement (e.g., a clickthrough rate, a conversion rate, etc.) of the user with the content item, and the like. Accordingly, the highest ranked content items from content items 310-C and/or content items 310-C having a ranking above a threshold ranking may be identified as content items 310-D, which may be a subset of content items 310-C and may be returned and provided by content ranking stage 306 to content serving stage 308.

Content serving stage 308 may employ one or more machine learning models, probabilistic models, rule-based models, and the like to make a further determination as to which content items may be provided to the user in response to the request for content items. As shown in FIG. 3, content items 310-E may have been identified, by content serving stage 308, from content items 310-D as a subset of content items 310-D to be provided to the user in response to the request for content items. Optionally, content serving stage 308 may also determine display parameters (e.g., position, duration, etc.) associated with the provided content items.

FIG. 3 also illustrates generating training dataset 320, which may be used to train content retrieval stage 304, from content items 310-B. As FIG. 3 illustrates an exemplary implementation where training dataset 320 is used to train the one or more machine learning models forming content retrieval stage 304, debiased training dataset 320 generated according to exemplary embodiments of the present disclosure is generated from the data (i.e., content items 310-B) that was served by content retrieval stage 304. In contrast, training data used to train content retrieval stage 304 has traditionally been generated from data generated from the output data generated by the multi-stage recommendation system (e.g., content items 310-E) and/or data served by later stages of the multi-stage recommendation system (e.g., content items 310-D returned by content ranking stage 306). However, as shown in FIG. 3, the distribution of the output data generated by the multi-stage recommendation system (e.g., content items 310-E) and/or data served by later stages of the multi-stage recommendation system (e.g., content items 310-D returned by content ranking stage 306) may be markedly different that the data actually served by content retrieval stage 304 (e.g., content items 310-B). Accordingly, generating training dataset 320 from content items 310-B to train content retrieval stage 304, e.g., the actual data served by content retrieval stage 304, in accordance with exemplary embodiments of the present disclosure, can mitigate the introduction of selection bias in the training dataset and can include a distribution of data that is more representative of the data that may be served by content retrieval stage 304.

In generating debiased training dataset 320, each content item of content items 310-B may be processed by a machine learning model to generate and assign pseudo-labels for each content item of content items 310-B. According to aspects of the present disclosure, the machine learning model used to generate the pseudo-labels may include one or more machine learning models that form content ranking stage 306. The pseudo-label generated and assigned to each data content item may represent a predicted relevancy and/or likelihood that the user may interact with each corresponding content item. In exemplary implementations, the pseudo-labels may include a numerical value (e.g., between 0 and 1) generated by the trained machine learning model that represents an expected relevance and/or likelihood that a user may interact with the corresponding data record. For example, the numerical value can include an expected click-through-rate (CTR), expected convergence rate (CVR), expected relevance score, expected cost per action, and the like, where a higher numerical value may indicate a greater likelihood and/or expectation that a user may interact with the corresponding data record and a lower numerical value may indicate a lower likelihood and/or expectation that a user may interact with the corresponding data record. Utilizing an existing machine learning model (e.g., content ranking stage 306) to generate the pseudo-labels for each data record can reduce the infrastructure cost, complexities, and the like in connection with training and maintaining a multi-stage recommendation system.

In addition to generating pseudo-labels for each content item of content items 310-B, exemplary implementations of the present disclosure also determine thresholds against which the generated pseudo-labels may be compared. The determined thresholds may include an upper threshold and a lower threshold, and comparison of the pseudo-labels against the upper and lower thresholds may facilitate determination of a binary classification of the content items. According to exemplary implementations, if the assigned pseudo-label of a content item is greater than the upper threshold, the content items may be assigned a positive label. Conversely, content items having pseudo-labels less than the lower threshold may be assigned a negative label. Further content items having pseudo-labels between the upper threshold and the lower threshold may be discarded and not included in training dataset 320. Debiased training dataset 320 may then be generated with the remaining content items that have been assigned positive labels and negative labels. Debiased training dataset 320 may then be used to train one or more machine learning models forming content retrieval stage 304.

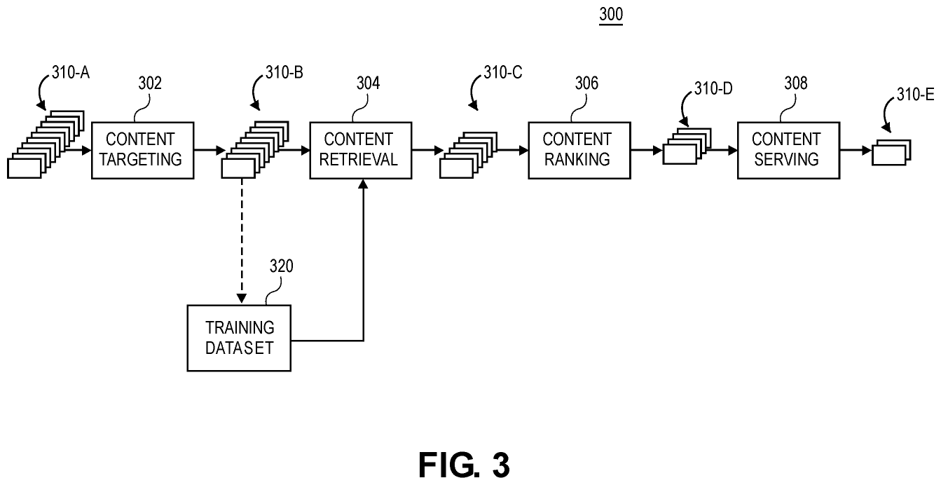

FIG. 4 is a flow diagram of an exemplary machine learning model training process 400, according to exemplary embodiments of the present disclosure. In exemplary implementations, exemplary machine learning model training process 400 may be employed to train one or more machine learning models that form a stage of a multi-stage recommendation system.

As shown in FIG. 4, exemplary machine learning model training process 400 may begin with obtaining an unbiased dataset, as in step 402. For example, the unbiased dataset may include a dataset on which the machine learning model to be trained serves. Accordingly, utilizing the data served by the machine learning model to be trained as the initial dataset to generate the debiased training dataset can mitigate the introduction of selection bias in the training dataset and can include a distribution of data that is more representative of the data that may be served by the stage of the multi-stage recommendation system to be trained. In an exemplary implementation of the present disclosure where the debiased training dataset is used to train one or more machine learning models associated with a retrieval stage of a multi-stage recommendation system, the debiased dataset may include the set of content items that is provided as an input to the retrieval stage of the multi-stage recommendation system.

In step 404, pseudo-labels may be determined for each data record of the unbiased dataset. According to aspects of the present disclosure, an existing machine learning model may be used to generate the pseudo-labels. In the exemplary implementation of the present disclosure where the generated debiased training dataset is used to train one or more machine learning models associated with a retrieval stage of a multi-stage recommendation system, the pseudo-labels may be generated by a machine learning model associated with another stage (e.g., a content ranking stage, etc.) of the multi-stage recommendation system. Further, the pseudo-labels generated and assigned to each data record may represent a predicted relevancy and/or likelihood that a user may interact with each data record.

In addition to generating pseudo-labels for the unbiased dataset, an upper threshold and a lower threshold may be determined in connection with the generated pseudo-labels, as in step 406. Comparison of the pseudo-labels against the upper and lower thresholds may facilitate determination of a binary classification of the content items. According to exemplary implementations of the present disclosure, the upper and lower thresholds may be determined based on user engagements in view of the pseudo-label values generated by the trained machine learning model used to generate the pseudo-labels (e.g., the content ranking stage). For example, data records may be divided into multiple buckets and/or ranges based on the pseudo-labels generated by the machine learning model (e.g., the content ranking stage), and the user engagements associated with the data records in each bucket and/or range may be processed to identify instances where sudden changes in user engagement exist between the buckets and/or ranges of pseudo-labels (e.g., the change in user engagement between neighboring buckets and/or ranges exceeds a threshold value, etc.). The upper and lower thresholds may be determined to correspond to the instances where the sudden changes in user engagement are identified.

After the data records are divided into multiple buckets and/or ranges based on the pseudo-labels generated by the machine learning model, an empirical user engagement measure (e.g., click-through-rate, conversion rate, cost per action, relevance, etc.) may be determined for each bucket and/or range. In exemplary implementations of the present disclosure, the empirical user engagement measure for each bucket and/or range may be determined by computing an actual user engagement value (e.g., click-through-rate, conversion rate, cost per action, relevance, etc.) for the data records that are associated with actual user interactions. Alternatively and/or in addition, a user engagement rate may be as the empirical user engagement measure for each bucket and/or range determined by dividing the number of actual user interactions in a particular bucket and/or range by the number of data records included in the particular bucket and/or range. Accordingly, in determining the lower threshold, the adjacent buckets and/or ranges between which a decrease in the empirical user engagement measure exceeds a threshold is determined, and one of the adjacent buckets and/or ranges is assigned as the lower threshold. Similarly, in determining the upper threshold, the adjacent buckets and/or ranges between which an increase in the empirical user engagement measure exceeds a threshold is determined, and one of the adjacent buckets and/or ranges is assigned as the upper threshold.

After generation of the pseudo-labels and the upper and lower thresholds, the pseudo-labels may be compared against the upper and lower thresholds, as in step 408. If the assigned pseudo-label of a data record is below the lower threshold, as in step 410, a negative label is assigned to the data record, as in step 412. Conversely, if the pseudo-label of a data record is greater than the upper threshold, as in step 418, a positive label may be assigned to the data record, as in step 420. Further, data records having pseudo-labels between the upper threshold and the lower threshold (e.g., step 414) may be discarded (e.g., step 416) and not included in the debiased training dataset. In step 422, it is determined whether additional data records are to be processed. If additional data records are to be processed, process 400 returns to step 408. Alternatively, in step 424, the debiased training dataset may then be generated with the un-discarded data records that have been assigned positive labels and negative labels, and the debiased training dataset may be used to train the machine learning model.

In training the machine learning model, each data record may be represented as a tuple of three elements: (u, a, y), where u may represent a feature of a request containing user information, contextual information, request information, and the like, a may represent content item information, and y may represent a label (e.g., observed user interactions with the content item), where <U, A> represents a distribution of request features and content features in inventory, and D=U×A represents a distribution of all request and candidate candidates pairs. Further, if F_{θ} represents the machine learning model with trainable parameter θ and l represents the loss function to be optimized, F_{θ}(u, a)→ [symbol] can represent the machine learning model that maps the request and candidate features to a numeric value and l (y, y)→ [symbol] can represent the loss function that maps two numeric values to a scalar (e.g., the loss value), Accordingly, the loss function to be minimized in training the machine learning model can be represented as:

$${min}_{θ} {L}_{ideal} ( {F}_{θ} ) = \frac{1}{\vert D \vert} {\sum }_{( u , a ) ∈ D} l ( y , {F}_{θ} ( u , a ) )$$

Accordingly, training the machine learning model utilizing the generated debiased training set can be represented as:

$${min}_{θ} {L}_{muda} ( {F}_{θ} ) = \frac{1}{\vert O \vert \cdot \vert D \vert} {\sum }_{( u , a ) ∈ O ⋃ D ⋀ ( R ( u , a ) \leq {δ}_{l} ⋁ R ( u , a ) \geq {δ}_{h} )} l ( {Φ}_{l}^{h} ( R ( u , a ) ) , {F}_{θ} ( u , a ) )$$

where let δₗ can represent the lower threshold, δₕ can represent the upper threshold, and Φ_{δ}_{ₗ}^{δ}^{ₕ}(·) can represent is a pseudo-label classification indicator, converting the pseudo-labels to binary classification labels (e.g., negative and positive labels based on comparisons with the upper and lower thresholds) in accordance with:

$${Φ}_{{δ}_{l}}^{{δ}_{h}} ( y ) = \{ \begin{matrix}1 , & if y \geq {δ}_{h} \\ - 1 , & if y \leq {δ}_{l}\end{matrix}$$

Optionally, aspects of the present disclosure can also provide continuous updating and/or evaluating of the trained machine learning model on a periodic basis. For example, the dataset that was served by the trained machine learning model during the previous period may be employed as the initial dataset from which the debiased training dataset is generated, and the newly generated debiased training dataset may be used to train the machine learning model so as to update the trained machine learning model based on the newly generated debiased training dataset.

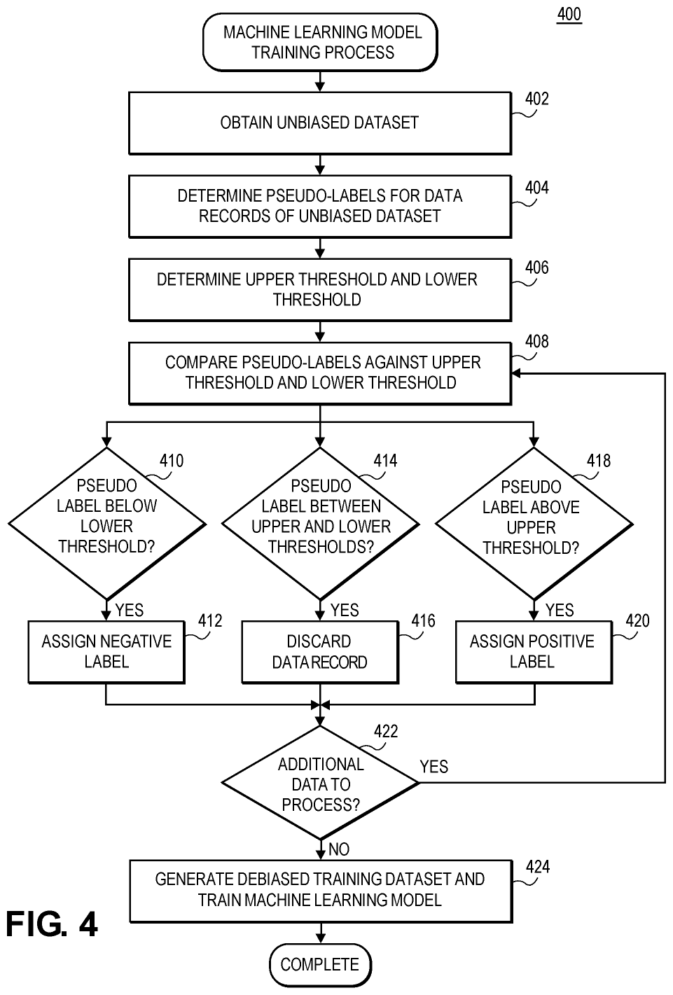

FIG. 5 is a flow diagram of an exemplary training process 500 for training a machine learning (ML) model (or other machine learning model, such as a DNN), according to exemplary embodiments of the present disclosure.

As shown in FIG. 5, training process 500 is configured to train an untrained ML model 534 operating on computer system 540 to transform untrained ML model 534 into trained ML model 536 that operates on the same or another computer system, such as computing resource 120. In the course of training, as shown in FIG. 5, at step 502, untrained ML model 534 is initialized with training criteria 530. Training criteria 530 may include, but is not limited to, information as to a type of training, and number of layers to be trained, etc.

At step 504 of training process 500, corpus of training data 532 may be accessed. For example, training data 532 may include a debiased training dataset generated in accordance with exemplary embodiments of the present disclosure.

With training data 532 accessed, at step 506, training data 532 may be divided into training and validation sets. Generally speaking, the items of data in the training set are used to train untrained ML model 534 and the items of data in the validation set are used to validate the training of the ML model. As those skilled in the art will appreciate, and as described below in regard to much of the remainder of training process 500, there are numerous iterations of training and validation that occur during the training of the ML model.

At step 508 of training process 500, the data items of the training set are processed, often in an iterative manner. Processing the data items of the training set include capturing the processed results. After processing the data items of the training set, at step 510, the aggregated results of processing the training set are evaluated, and at step 512, a determination is made as to whether a desired performance level has been achieved. If the desired performance level is not achieved, in step 514, aspects of the machine learning model are updated in an effort to guide the machine learning model to improve its performance, and processing returns to step 506, where a new set of training data is selected, and the process repeats. Alternatively, if the desired performance is achieved, training process 500 advances to step 516.

At step 516, and much like step 508, the data items of the validation set are processed, and at step 518, the processing performance of this validation set is aggregated and evaluated. At step 520, a determination is made as to whether a desired performance level, in processing the validation set, has been achieved. If the desired performance level is not achieved, in step 514, aspects of the machine learning model are updated in an effort to guide the machine learning model to improve its performance, and processing returns to step 506. Alternatively, if the desired accuracy level is achieved, the training process 500 advances to step 522. At step 522, a finalized, trained ML model 536 is generated. Typically, though not exclusively, as part of finalizing the now-trained ML model 536, portions of the ML model that are included in the model during training for training purposes are extracted, thereby generating a more efficient trained ML model 536.

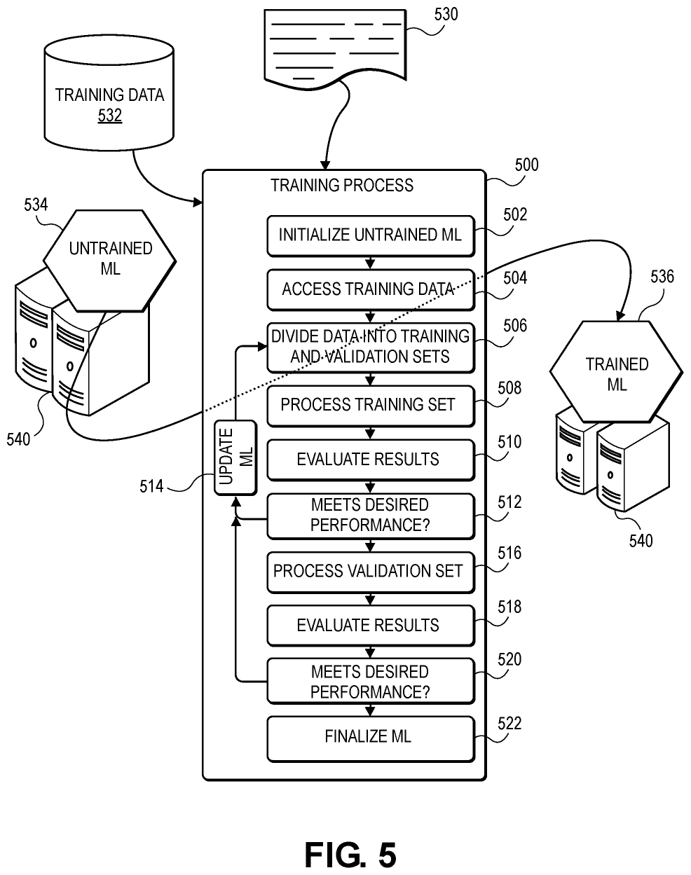

FIG. 6 illustrates an exemplary client device 600 that can be used in accordance with various implementations described herein. In this example, client device 600 includes display 602, and optionally, at least one input component 604, such as a camera, on a same side and/or opposite side of the device as display 602. Client device 600 may also include an audio transducer, such as speaker 606, and microphone 608. Generally, client device 600 may have any form of input/output components that allow a user to interact with client device 600. For example, the various input components for enabling user interaction with the device may include touch-based display 602 (e.g., resistive, capacitive, Interpolating Force-Sensitive Resistance (IFSR)), camera (for gesture tracking, etc.), microphone, global positioning system (GPS), compass or any combination thereof. One or more of these input components may be included on a user device or otherwise in communication with the user device. Various other input components and combinations of input components can be used as well within the scope of the various implementations, as should be apparent in light of the teachings and suggestions contained herein.

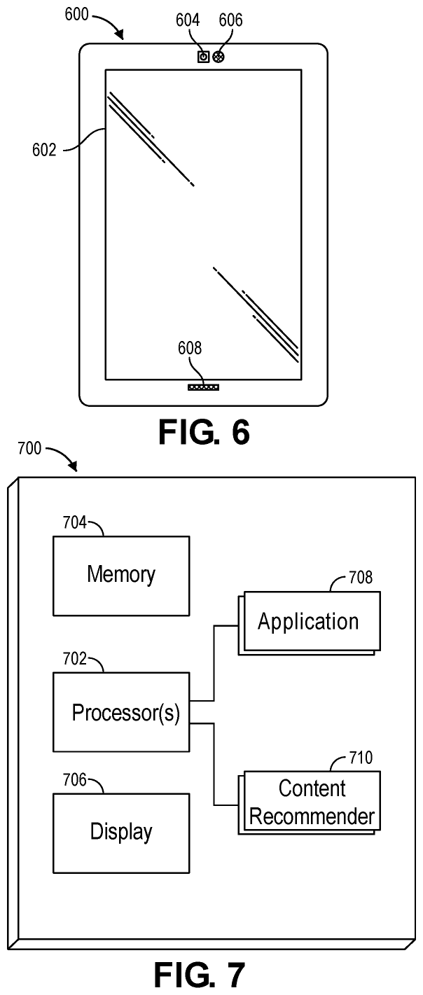

In order to provide the various functionality described herein, FIG. 7 illustrates an exemplary set of components 700 of client device 600, as described with respect to FIG. 6 and discussed herein. In this example, the device includes at least one central processor 702 for executing instructions that can be stored in at least one memory device or element 704. As would be apparent to one of ordinary skill in the art, the device can include many types of memory, data storage or computer-readable storage media, such as a first data storage for program instructions for execution by the one or more processors 702. Removable storage memory can be available for sharing information with other devices, etc. The device typically will include some type of display 706, such as a touch-based display, electronic ink (e-ink), organic light emitting diode (OLED), liquid crystal display (LCD), etc.

As discussed, the device can include at least one application component 708 for performing the implementations discussed herein. Optionally, the device can include a content recommendation system, such as content recommender 710, which can be configured to determine recommended content for presentation to a user according to the implementations described herein. The user device may be in constant or intermittent communication with one or more remote computing resources and may exchange information with the remote computing system(s) as part of the disclosed implementations.

The device also can include at least one location component, such as GPS, NFC location tracking. Wi-Fi location monitoring, etc. The example client device 600 may also include at least one additional input device able to receive conventional input from a user. This conventional input can include, for example, a push button, touch pad, touch-based display, wheel, joystick, keyboard, mouse, trackball, keypad or any other such device or element whereby a user can submit an input to the device. These I/O devices could be connected by a wireless, infrared, Bluetooth, or other link as well in some implementations. In some implementations, however, such a device might not include any buttons at all and might be controlled only through touch inputs (e.g., touch-based display), audio inputs (e.g., spoken), or a combination thereof.

FIG. 8 is a pictorial diagram of an illustrative implementation of an exemplary server system 800 that may be used with one or more of the implementations described herein (e.g., computing resources 120). Server system 800 may include one or more processors 802, such as one or more redundant processors, video display adapter 804, disk drive 806, input/output interface 808, network interface 810, and memory 812. Processor(s) 802, video display adapter 804, disk drive 806, input/output interface 808, network interface 810, and memory 812 may be communicatively coupled to each other by communication bus 820.

Video display adapter 804 provides display signals to a local display, permitting an operator of server system 800 to monitor and configure operation of server system 800. Input/output interface 808 likewise communicates with external input/output devices not shown in FIG. 8, such as a mouse, keyboard, scanner, or other input and output devices that can be operated by an operator of server system 800. Network interface 810 includes hardware, software, or any combination thereof, to communicate with other computing devices. For example, network interface 810 may be configured to provide communications between server system 800 and other computing devices, such as client device 110 and/or 600.

Memory 812 generally comprises random access memory (RAM), read-only memory (ROM), flash memory, and/or other volatile or permanent memory. Memory 812 is shown storing operating system 814 for controlling the operation of server system 800. Server system 800 may also include content recommendation system 816, as discussed herein. In some implementations, content recommendation system 816 may include a multi-stage content recommendation system configured to determine and/or identify recommended content to be presented to a user. In other implementations, trained content recommendation system 816 may exist on both server system 800 and/or each client device (e.g., content recommender 710).

Memory 812 additionally stores program code and data for providing network services that allow client devices and external sources to exchange information and data files with server system 800. Memory 812 may also include content recommendation system 816, which may communicate with a data store manager application to facilitate data exchange and mapping between the data store 830 (e.g., candidate content item datastore 130), user/client devices, such as client devices 110 and/or 600, external sources, etc.

As used herein, the term “data store” refers to any device or combination of devices capable of storing, accessing and retrieving data, which may include any combination and number of data servers, databases, data storage devices and data storage media, in any standard, distributed or clustered environment. Server system 800 can include any appropriate hardware and software for integrating with the data store 830 as needed to execute aspects of one or more applications for the client device 110 and/or 600, the external sources, etc.

Data store 830 can include several separate data tables, databases or other data storage mechanisms and media for storing data relating to a particular aspect. For example, data store 830 as illustrated may store and/or maintain digital content items (e.g., images, videos, advertisements, etc.) and corresponding metadata (e.g., image segments, popularity, source) about those items.

It should be understood that there can be many other aspects that may be stored in data store 830, which can be stored in any of the above listed mechanisms as appropriate or in additional mechanisms of any of the data store. Data store 830 may be operable, through logic associated therewith, to receive instructions from server system 800 and obtain, update or otherwise process data in response thereto.

Server system 800, in one implementation, is a distributed environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 8. Thus, the depiction in FIG. 8 should be taken as being illustrative in nature and not limiting to the scope of the disclosure.

Aspects of the disclosed system may be implemented as a computer method or as an article of manufacture such as a memory device or non-transitory computer readable storage medium. The computer readable storage medium may be readable by a computer and may comprise instructions for causing a computer or other device to perform processes described in the present disclosure. The computer readable storage media may be implemented by a volatile computer memory, non-volatile computer memory, hard drive, solid-state memory, flash drive, removable disk, and/or other media. In addition, components of one or more of the modules and engines may be implemented in firmware or hardware.

The above aspects of the present disclosure are meant to be illustrative. They were chosen to explain the principles and application of the disclosure and are not intended to be exhaustive or to limit the disclosure. Many modifications and variations of the disclosed aspects may be apparent to those of skill in the art. Persons having ordinary skill in the field of computers, communications, media files, and machine learning should recognize that components and process steps described herein may be interchangeable with other components or steps, or combinations of components or steps, and still achieve the benefits and advantages of the present disclosure. Moreover, it should be apparent to one skilled in the art that the disclosure may be practiced without some, or all of the specific details and steps disclosed herein.

Moreover, with respect to the one or more methods or processes of the present disclosure shown or described herein, including but not limited to the flow charts shown in FIGS. 4 and 5, orders in which such methods or processes are presented are not intended to be construed as any limitation on the claims, and any number of the method or process steps or boxes described herein can be combined in any order and/or in parallel to implement the methods or processes described herein. In addition, some process steps or boxes may be optional. Also, the drawings herein are not drawn to scale.

Aspects of the disclosed system may be implemented as a computer method or as an article of manufacture such as a memory device or non-transitory computer readable storage medium. The computer readable storage medium may be readable by a computer and may comprise instructions for causing a computer or other device to perform processes described in the present disclosure. The computer readable storage media may be implemented by a volatile computer memory, non-volatile computer memory, hard drive, solid-state memory, flash drive, removable disk, and/or other media. In addition, components of one or more of the modules and engines may be implemented in firmware or hardware.

Disjunctive language such as the phrase “at least one of X, Y, or Z,” or “at least one of X, Y and Z,” unless specifically stated otherwise, is otherwise understood with the context as used in general to present that an item, term, etc., may be any of X, Y, or Z, or any combination thereof (e.g., X, Y, and/or Z). Thus, such disjunctive language is not generally intended to, and should not, imply that certain implementations require at least one of X, at least one of Y, or at least one of Z to each be present.

Unless otherwise explicitly stated, articles such as “a” or “an” should generally be interpreted to include one or more described items. Accordingly, phrases such as “a device configured to” or “a device operable to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

Language of degree used herein, such as the terms “about,” “approximately,” “generally,” “nearly” or “substantially” as used herein, represent a value, amount, or characteristic close to the stated value, amount, or characteristic that still performs a desired function or achieves a desired result. For example, the terms “about,” “approximately,” “generally,” “nearly” or “substantially” may refer to an amount that is within less than 10% of, within less than 5% of, within less than 1% of, within less than 0.1% of, and within less than 0.01% of the stated amount.

Conditional language, such as, among others, “can,” “could,” “might,” or “may,” unless specifically stated otherwise, or otherwise understood within the context as used, is generally intended to convey in a permissive manner that certain implementations could include, or have the potential to include, but do not mandate or require, certain features, elements and/or steps. In a similar manner, terms such as “include,” “including” and “includes” are generally intended to mean “including, but not limited to.” Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation.

Although the invention has been described and illustrated with respect to illustrative implementations thereof, the foregoing and various other additions and omissions may be made therein and thereto without departing from the spirit and scope of the present disclosure.

What is claimed is:

1. A computer-implemented method for training a first machine learning model using a debiased dataset, comprising:
obtaining a first dataset including a first plurality of data records;
processing the first dataset using a second machine learning model to generate a respective pseudo-label for each data record of the first plurality of data records;
comparing the respective pseudo-label for each data record of the plurality of data records against at least one of a first threshold or a second threshold;
in response to comparing each respective pseudo-label against at least one of the first threshold or the second threshold, performing, for each data record of the first plurality of data records, one of:
determining that the respective pseudo-label exceeds the first threshold and assigning a positive label to the data record;
determining that the respective pseudo-label is lower than the second threshold and assigning a negative label to the data record; or
determining that the respective pseudo-label is between the first threshold and the second threshold and discarding the data record;
generating a second dataset including a second plurality of data records from the first plurality of data records based at least in part on the data records of the first plurality of data records that were assigned positive labels, the data records of the first plurality of data records that were assigned negative labels, and the discarded data records of the first plurality of data records, such that the second plurality of data records includes data records from the first plurality of data records having positive labels and data records from the first plurality of data records having negative labels;
generating a debiased training dataset from the second dataset; and
training the first machine learning model using the debiased training dataset.

2. The computer-implemented method of claim 1, wherein the first machine learning model is employed as a first stage of a multi-stage content recommendation system.

3. The computer-implemented method of claim 2, wherein the second machine learning model is employed as a second stage of the multi-stage content recommendation system.

4. The computer-implemented method of claim 2, wherein the first dataset was previously served by the first stage of the multi-stage content recommendation system.

5. The computer-implemented method of claim 1, further comprising:
determining the first threshold and the second threshold based at least in part on changes in user interactions associated with the first plurality of data records.

6. A computer-implemented method for generating a debiased dataset for training a first machine learning model, comprising:
obtaining a first dataset that includes a first plurality of data records and was previously served by the first machine learning model;
generating, using a second machine learning model, a plurality of corresponding pseudo-labels corresponding to the first plurality of data records;
determining an upper pseudo-label threshold;
determining a lower pseudo-label threshold;
comparing each of the plurality of corresponding pseudo-labels corresponding to the first plurality of data records against at least one of the upper pseudo-label threshold or the lower pseudo-label threshold;
in response to comparing each of the plurality of corresponding pseudo-labels against at least one of the upper pseudo-label threshold or the lower pseudo-label threshold, performing, for each corresponding data record of the first plurality of data records, one of:
determining that the pseudo-label exceeds the upper pseudo-label threshold and associating a positive label with the corresponding data record;
determining that the pseudo-label is lower than the lower pseudo-label threshold and associating a negative label with the corresponding data record; or
determining that the pseudo-label is between the first threshold and the second threshold and discarding the corresponding data record;
generating a second dataset including data records from the first plurality of data records that are associated with the positive label or the negative label; and
generating a debiased training dataset from the second dataset.

7. The computer-implemented method of claim 6, further comprising:
training the first machine learning model using the debiased training dataset,
wherein the first machine learning model forms at least a portion of a multi-stage content recommendation system.

8. The computer-implemented method of claim 7, further comprising:
receiving a request for content items;
determining, using the multi-stage content recommendation system, at least one content item from a corpus of content items as recommended content in response to the request for content items.

9. The computer-implemented method of claim 8, wherein the recommended content is determined online in real-time.

10. The computer-implemented method of claim 8, wherein the recommended content includes at least one of:
images;
videos;
documents; or
advertisements.

11. The computer-implemented method of claim 6, wherein determining the lower pseudo-label threshold and determining the upper pseudo-label threshold is based at least in part on changes in user interactions associated with the first plurality of data records.

12. The computer-implemented method of claim 11, wherein determining the lower pseudo-label threshold and determining the upper pseudo-label threshold includes:
sorting the first plurality of data records into a plurality of pseudo-label ranges based on the plurality of corresponding pseudo-labels;
comparing empirical user engagement measures associated with data records sorted into each of the plurality of pseudo-label ranges;
identifying changes in the empirical user engagement measures that exceed one or more threshold values based on the comparison of the empirical user engagement measures associated with data records sorted into each of the plurality of pseudo-label ranges; and
determining the lower pseudo-label threshold and the upper pseudo-label threshold based at least in part on the identification of changes in the empirical user engagement measures that exceed the one or more threshold values.

13. The computer-implemented method of claim 6, wherein:
the first machine learning model is employed as a first stage of a multi-stage content recommendation system; and
the second machine learning model is employed as a second stage of the multi-stage content recommendation system.

14. The computer-implemented method of claim 12, wherein:
the first stage includes a content retrieval stage; and
the second stage includes a content ranking stage.

15. A computing system, comprising:
one or more processors;
a memory storing program instructions that, when executed by the one or more processors, cause the one or more processors to at least:
obtain a first dataset that includes a first plurality of data records and was previously served by a first machine learning model of a multi-stage content recommendation service;
generate, using a second machine learning model of the multi-stage content recommendation service, a respective pseudo-label for each of the first plurality of data records;
determine an upper pseudo-label threshold;
determine a lower pseudo-label threshold;
compare each respective pseudo-label against at least one of the upper pseudo-label threshold or the lower pseudo-label threshold;
in response to the comparison of each respective pseudo-label against at least one of the upper pseudo-label threshold or the lower pseudo-label threshold, perform, for each corresponding data record of the first plurality of data records, one of:
determine that the respective pseudo-label exceeds the upper pseudo-label threshold and associate a positive label with the corresponding data record;
determine that the respective pseudo-label is lower than the lower pseudo-label threshold and associate a negative label with the corresponding data record; or
determine that the pseudo-label is between the first threshold and the second threshold and discard the corresponding data record;
generate a second dataset including data records from the first plurality of data records that are associated with the positive label or the negative label;
generating a debiased training dataset from the second dataset;
train the first machine learning model using the debiased training dataset;
receive a request for content items;
determine, using the multi-stage content recommendation system, at least one content item from a corpus of content items as recommended content in response to the request for content items.

16. The computing system of claim 15, wherein:
the first machine learning model forms at least a portion of a content retrieval stage of the multi-stage content recommendation system; and
the second machine learning model forms at least a portion of a content ranking stage of the multi-stage content recommendation system.

17. The computing system of claim 15, wherein determination of the lower pseudo-label threshold and determination of the upper pseudo-label threshold is based at least in part on changes in user interactions associated with the first plurality of data records.

18. The computing system of claim 17, wherein determination of the lower pseudo-label threshold and determination of the upper pseudo-label threshold includes:
sorting the first plurality of data records into a plurality of pseudo-label ranges based on the plurality of corresponding pseudo-labels;
comparing empirical user engagement measures associated with data records sorted into each of the plurality of pseudo-label ranges;
identifying an increase in the empirical user engagement measures that exceeds a first threshold value based on the comparison of the empirical user engagement measures associated with data records sorted into each of the plurality of pseudo-label ranges;
identifying a decrease in the empirical user engagement measures that exceeds a second threshold value based on the comparison of the empirical user engagement measures associated with data records sorted into each of the plurality of pseudo-label ranges;
determining the upper pseudo-label threshold based at least in part on the identification of the increase in the empirical user engagement measures that exceeds the first threshold value; and
determining the lower pseudo-label threshold based at least in part on the identification of the decrease in the empirical user engagement measures that exceeds the second threshold value.

19. The computing system of claim 15, wherein determination of the at least one content item from the corpus of content items as recommended content in response to the request for content items includes determining a dot product of a user embedding representative of a user associated with the request for content items and a query embedding representative of the request for content items.

20. The computing system of claim 15, wherein the program instructions, that when executed by the one or more processors, further cause the one or more processors to at least:
periodically generate an updated debiased training dataset; and
periodically update the first machine learning model using the updated debiased training dataset.
